(19) United States
(12) Patent Application Publication
(10) Pub. No.: US 2026/0074738 A1
(43) Pub. Date: Mar. 12, 2026

(54) TRANSCEIVER DEVICE, PRE-DISTORTION CIRCUIT, AND PRE-DISTORTION COMPENSATION SIGNAL GENERATION METHOD

(71) Applicant: Realtek Semiconductor Corporation, Hsinchu (TW)

(72) Inventors: Xiao XIAO, Jiangsu Province (CN); Chien-Lun PENG, Hsinchu (TW); Yuan-Shuo CHANG, Hsinchu (TW); Chen ZHU, Jiangsu Province (CN)

(21) Appl. No.: 19/300,674

(22) Filed: Aug. 15, 2025

(30) Foreign Application Priority Data
Sep. 6, 2024 (CN) 202411252629.5

(51) Int. Cl. H04B 1/62; H04B 1/40

(52) U.S. Cl. CPC H04B 1/62; H04B 1/40

(57) ABSTRACT

A transceiver device includes a pre-distortion circuit and a radio frequency end circuit. The pre-distortion circuit is configured to output a first baseband signal. The first baseband signal is a non-continuous single-tone signal. The radio frequency end circuit is coupled to the pre-distortion circuit. The radio frequency end circuit includes a transmitter circuit and a receiver circuit. The transmitter circuit includes a power amplifier and is configured to output a loop-back signal according to the first baseband signal. The receiver circuit is configured to receive the loop-back signal. The pre-distortion circuit is further configured to receive a second baseband signal generated according to the loop-back signal, and generate a pre-distortion compensation signal according to the first baseband signal and the second baseband signal. The pre-distortion compensation signal corresponds to a non-linear characteristic of the power amplifier.

### RELATED APPLICATIONS

This application claims priority to Chinese Application Serial Number 202411252629.5, filed Sep. 6, 2024, which is herein incorporated by reference.

### BACKGROUND

### Technical Field

The present disclosure relates to pre-distortion technology. More particularly, the present disclosure relates to a transceiver device, a pre-distortion circuit, and a pre-distortion compensation signal generation method that can reduce the peak current.

### Description of Related Art

With developments of technology, various communication systems and technologies of processing signals are developed. For example, the pre-distortion technology can be used to compensate the non-linear characteristic of power amplifiers in communication devices to reduce attenuation of signals.

### SUMMARY

Some aspects of the present disclosure are to provide a transceiver device. The transceiver device includes a pre-distortion circuit and a radio frequency end circuit. The pre-distortion circuit is configured to output a first baseband signal. The first baseband signal is a non-continuous single-tone signal. The radio frequency end circuit is coupled to the pre-distortion circuit. The radio frequency end circuit includes a transmitter circuit and a receiver circuit. The transmitter circuit includes a power amplifier and is configured to output a loop-back signal according to the first baseband signal. The receiver circuit is configured to receive the loop-back signal. The pre-distortion circuit is further configured to receive a second baseband signal generated according to the loop-back signal, and generate a pre-distortion compensation signal according to the first baseband signal and the second baseband signal. The pre-distortion compensation signal corresponds to a non-linear characteristic of the power amplifier.

Some aspects of the present disclosure are to provide a pre-distortion circuit. The pre-distortion circuit includes a pre-distortion compensation circuit and a pre-distortion training circuit. The pre-distortion compensation circuit is configured to output a first baseband signal to a transmitter circuit including a power amplifier such that the transmitter circuit outputs a feedback signal. The first baseband signal is a discontinuous single-tone signal. The pre-distortion training circuit is configured to receive a second baseband signal generated according to the feedback signal, and generate a pre-distortion compensation signal according to the first baseband signal and the second baseband signal. The pre-distortion compensation signal corresponds to a non-linear characteristic of the power amplifier.

Some aspects of the present disclosure are to provide a pre-distortion compensation signal generation method. The pre-distortion compensation signal generation method includes following operations: outputting, by a pre-distortion compensation circuit, a first baseband signal to a transmitter circuit comprising a power amplifier such that the transmitter circuit output s a feedback signal, wherein the first baseband signal is a discontinuous single-tone signal; receiving, by a pre-distortion training circuit, a second baseband signal generated according to the feedback signal; and generating, by the pre-distortion training circuit, a pre-distortion compensation signal according to the first baseband signal and the second baseband signal. The pre-distortion compensation signal corresponds to a non-linear characteristic of the power amplifier.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a transceiver device in a pre-distortion mode according to some embodiments of the present disclosure.

FIG. 2 is a schematic diagram of the transceiver device in FIG. 1 in a normal mode according to some embodiments of the present disclosure.

FIG. 3 is a schematic diagram of a baseband signal according to some embodiments of the present disclosure.

FIG. 4 is an enlarged schematic diagram of a sine-wave group in FIG. 3.

FIG. 5 is a flow diagram of a pre-distortion compensation signal generation method according to some embodiments of the present disclosure.

### DETAILED DESCRIPTION

In the present disclosure, “connected” or “coupled” may refer to “electrically connected” or “electrically coupled.” “Connected” or “coupled” may also refer to operations or actions between two or more elements.

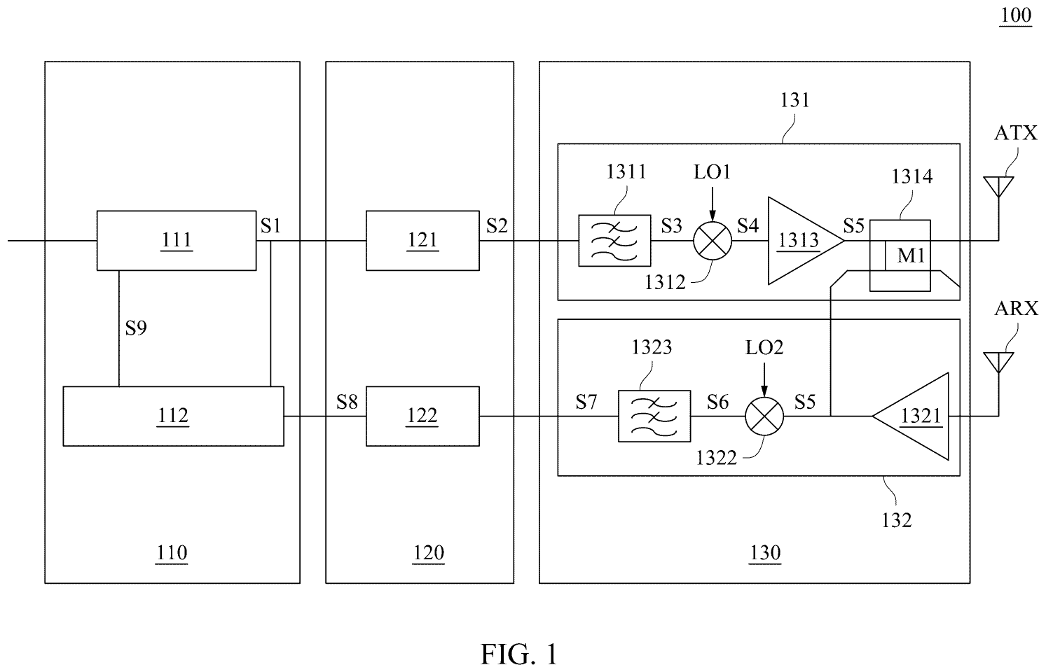

Reference is made to FIG. 1. FIG. 1 is a schematic diagram of a transceiver device 100 in a pre-distortion mode according to some embodiments of the present disclosure.

In some embodiments, the transceiver device 100 can adopt Wi-Fi wireless communication technology. In some embodiments, the transceiver device 100 can be applied to microwave transceiver systems.

As illustrated in FIG. 1, the transceiver device 100 includes a pre-distortion circuit 110, an analog front-end circuit 120, and a radio frequency end circuit 130. The pre-distortion circuit 110 is coupled to the analog front-end circuit 120. The analog front-end circuit 120 is coupled to the radio frequency end circuit 130. In other words, the radio frequency end circuit 130 is coupled to the pre-distortion circuit 110 through the analog front-end circuit 120.

The pre-distortion circuit 110 includes a pre-distortion compensation circuit 111 and a pre-distortion training circuit 112. The pre-distortion compensation circuit 111 is coupled to the pre-distortion training circuit 112.

The analog front-end circuit 120 includes a digital-to-analog converter circuit 121 and an analog-to-digital converter circuit 122. The digital-to-analog converter circuit 121 is coupled to the pre-distortion compensation circuit 111. The analog-to-digital converter circuit 122 is coupled to the pre-distortion training circuit 112.

The radio frequency end circuit 130 includes a transmitter circuit 131 and a receiver circuit 132. The transmitter circuit 131 is coupled to the digital-to-analog converter circuit 121 and a transmission antenna ATX. The receiver circuit 132 is coupled to the analog-to-digital converter circuit 122 and a receiving antenna ARX.

The transmitter circuit 131 includes a filter 1311, a mixer 1312, a power amplifier 1313, and a switching circuit 1314. In some embodiments, the switching circuit 1314 includes a switch M1. The transmission antenna ATX is configured to transmit wireless signals.

The receiver circuit 132 includes a low noise amplifier 1321, a mixer 1322, and a filter 1323. The receiving antenna ARX is configured to receive wireless signals.

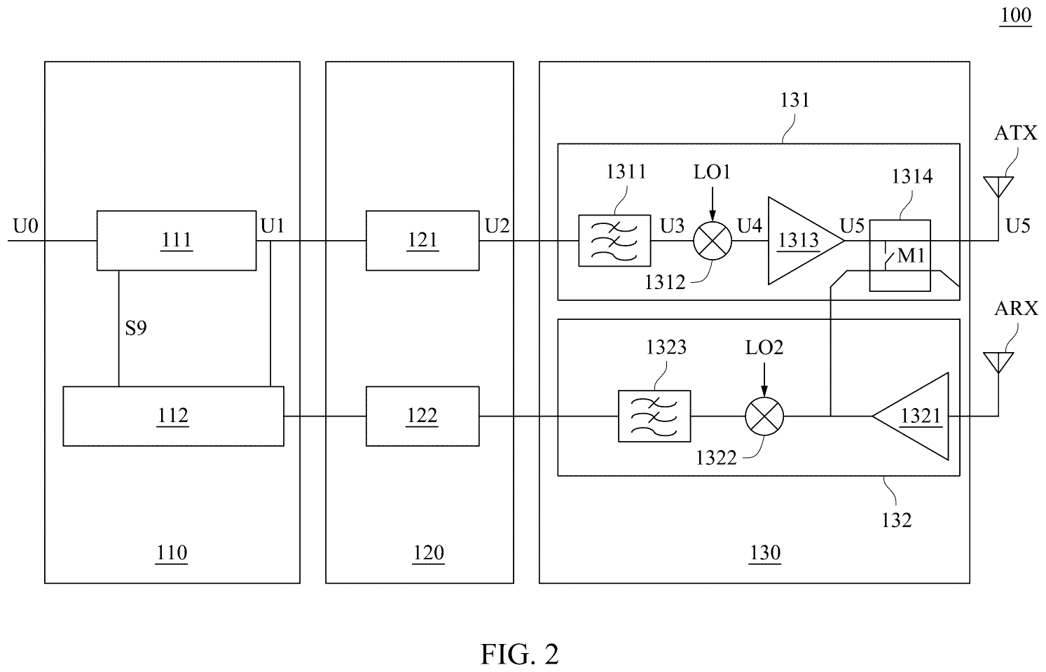

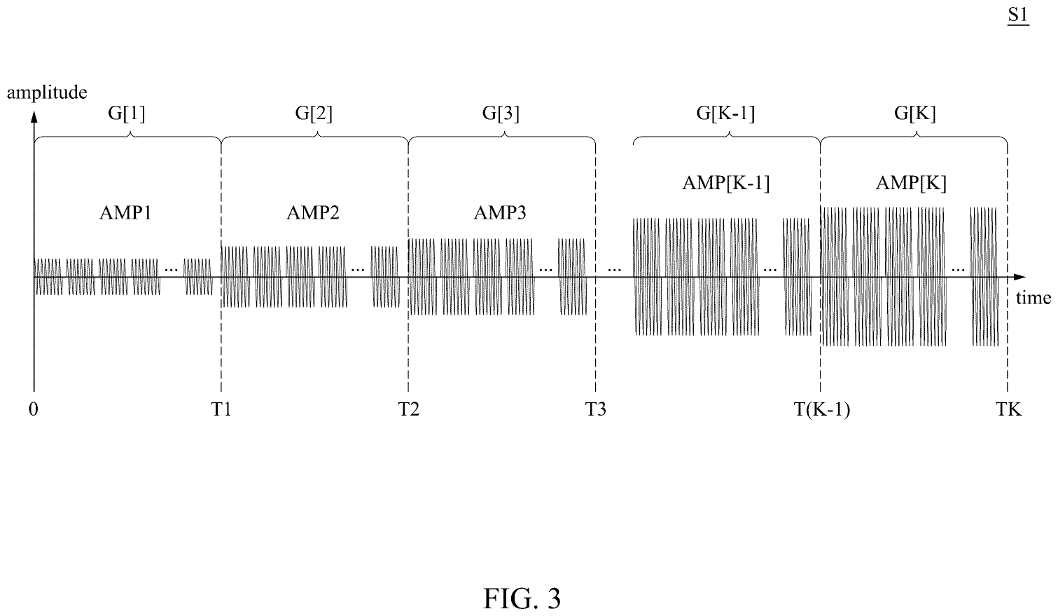

In the pre-distortion mode, the pre-distortion compensation circuit 111 is configured to output a baseband signal S1 to the transmitter circuit 131 including the power amplifier 1313. The baseband signal S1 is a discontinuous single-tone signal. Details about the discontinuous single-tone signal will be described in following paragraphs with reference to FIG. 2 and FIG. 3. The transmitter circuit 131 is configured to output a feedback signal S5 to the receiver circuit 132 according to the baseband signal S1. To be more specific, the pre-distortion compensation circuit 111 outputs the baseband signal S1 to the digital-to-analog converter circuit 121. The digital-to-analog converter circuit 121 performs a digital-to-analog conversion on the baseband signal S1 to output an analog signal S2. The filter 1311 performs a filtering process on the analog signal S2 to output a filtered signal S3. The mixer 1312 performs a frequency-mixing process (frequency-increasing process) on the filtered signal S3 and an oscillation signal LO1 to output a frequency-mixed signal S4. The power amplifier 1313 performs an amplifying process on the frequency-mixed signal S4 to output the feedback signal S5. In the pre-distortion mode, the switch M1 in the switching circuit 1314 is turned on to feed back the feedback signal S5 to the receiver circuit 132.

The receiver circuit 132 is configured to receive the feedback signal S5. To be more specific, the mixer 1322 performs a frequency-mixing process (frequency-decreasing process) on the feedback signal S5 and an oscillation signal LO2 to output a frequency-mixed signal S6. The filter 1323 performs a filtering process on the frequency-mixed signal S6 to output a filtered signal S7. The analog-to-digital converter circuit 122 performs an analog-to-digital conversion on the filtered signal S7 to output a baseband signal S8.

Then, the pre-distortion training circuit 112 is configured to receive the baseband signal S8 generated according to the feedback signal S5, and generate a pre-distortion compensation signal S9 according to the baseband signal S1 and the baseband signal S8. The pre-distortion compensation signal S9 corresponds to the non-linear characteristic of the power amplifier 1313. To be more specific, the pre-distortion training circuit 112 can perform a calculation on the baseband signal S1 and the baseband signal S8 to generate the pre-distortion compensation signal S9. The pre-distortion compensation signal S9 can be an inverse of the non-linear characteristic of the power amplifier 1313. Accordingly, the pre-distortion compensation signal S9 can compensate (cancel) the non-linear characteristic of the power amplifier 1313. Then, the pre-distortion training circuit 112 outputs the pre-distortion compensation signal S9 to the pre-distortion compensation circuit 111.

Reference is made to FIG. 2. FIG. 2 is a schematic diagram of the transceiver device 100 in FIG. 1 in a normal mode according to some embodiments of the present disclosure.

When the pre-distortion compensation signal S9 is generated, the transceiver device 100 can enter the normal mode. In the normal mode, the pre-distortion compensation circuit 111 receives an original transmission signal U0 (a signal the transceiver device 100 actually intends to transmit) from a signal generator circuit. Then, the pre-distortion compensation circuit 111 is configured to combine the original transmission signal U0 and the pre-distortion compensation signal S9, and output a combination signal U1 of the original transmission signal U0 and the pre-distortion compensation signal S9. Then, similarly, the pre-distortion compensation circuit 111 outputs the combination signal U1 to the digital-to-analog converter circuit 121. The digital-to-analog converter circuit 121 performs a digital-to-analog conversion on the combination signal U1 to output an analog signal U2. The filter 1311 performs a filtering process on the analog signal U2 to output a filtered signal U3. The mixer 1312 performs a frequency-mixing process (frequency-increasing process) on the filtered signal U3 and the oscillation signal LO1 to output a frequency-mixed signal U4. The power amplifier 1313 performs an amplifying process on the frequency-mixed signal U4 to output a transmission signal U5. In the normal mode, the switch M1 in the switching circuit 1314 is turned off. Accordingly, the transmission signal U5 can be transmitted through the transmission antenna ATX.

Since the combination signal U1 includes the pre-distortion compensation signal S9 and the pre-distortion compensation signal S9 can be configured to compensate (cancel) the non-linear characteristic of the power amplifier 1313, the signal is passed through a (almost) linear system. Accordingly, attenuated portions of the transmission signal U5 that are attenuated due to the non-linear characteristic of the power amplifier 1313 are reduced.

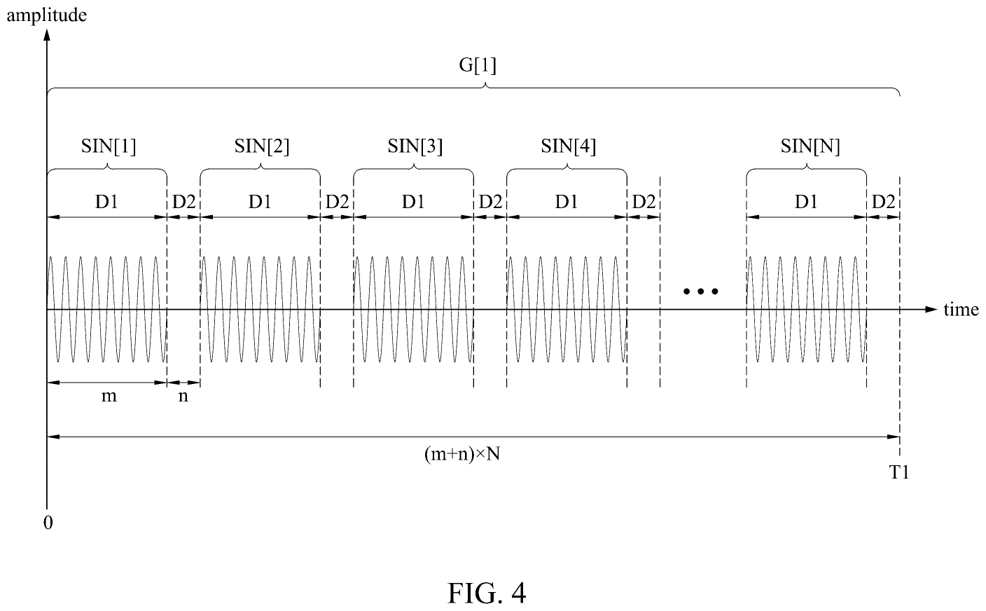

References are made to FIG. 3 and FIG. 4. FIG. 3 is a schematic diagram of the baseband signal S1 according to some embodiments of the present disclosure. FIG. 4 is an enlarged schematic diagram of a sine-wave group G[1] in FIG. 3.

As described above, the baseband signal S1 is the discontinuous single-tone signal. As illustrated in FIG. 3 and FIG. 4, the discontinuous single-tone signal includes K sine-wave groups G[1]-G[K], and each of the K sine-wave groups G[1]-G[K] includes N discontinuous sine waves SIN[1]-SIN[N]. K is a positive integer number greater than 1. N is a positive integer number greater than 1.

As illustrated in FIG. 3, the baseband signal S1 includes a sine-wave group G[1], a sine-wave group G[2], a sine-wave group G[3] . . . a sine-wave group G[K−1], and a sine-wave group G[K] in a time sequence.

The sine-wave groups G[1]-G[K] are with different amplitudes. As illustrated in FIG. 3, the sine-wave group G[1] is with the amplitude AMP1. The sine-wave group G[2] is with the amplitude AMP2. The sine-wave group G[3] is with the amplitude AMP3. The sine-wave group G[K−1] is with the amplitude AMP[K−1]. The sine-wave group G[K] is with the amplitude AMP[K].

Furthermore, a former one of the sine-wave groups G[1]-G[K] in the time sequence is with a first amplitude, and a latter one of the sine-wave groups G[1]-G[K] in the time sequence is with a second amplitude. The second amplitude is greater than the first amplitude. As illustrated in FIG. 3, the amplitude AMP2 of the sine-wave group G[2] is greater than the amplitude AMP1 of the sine-wave group G[1], the amplitude AMP3 of the sine-wave group G[3] is greater than the amplitude AMP2 of the sine-wave group G[2], and so on. In other words, the amplitudes AMP1-AMP[K] sequentially become lager.

Taking the sine-wave group G[1] as an example, as illustrated in FIG. 4, the sine-wave group G[1] includes a sine wave SIN[1], a sine wave SIN[2], a sine wave SIN[3], a sine wave SIN[4] . . . and a sine wave SIN[N] in the time sequence. The sine waves SIN[1]-SIN[N] are with the same amplitude AMP1.

Each of the sine waves SIN[1]-SIN[N] includes a signal time interval D1. There is an idle time interval D2 between any two adjacent sine waves of the sine waves SIN[1]-SIN[N]. There is also an idle time interval D2 between the last sine wave SIN[N] and a next sine-wave group G[2]. It is assumed that a time length of the signal time interval D1 is m and a time length of the idle time interval D2 is n. Accordingly, a time length of the entire sine-wave group G[1] is (m+n)×N.

Reference is made to FIG. 3 again. Other sine-wave groups G[2]-G[K] have similar architectures, so the time length of each of the sine-wave groups G[2]-G[K] is also (m+n)×N. Accordingly, a time length of the entire baseband signal S1 is (m+n)×N×K.

It is assumed that a starting time point of the sine-wave group G[1] is 0. An ending time point of the sine-wave group G[1] is a time point T1. An ending time point T2 of the sine-wave group G[2] is equivalent to two times T1. An ending time point T3 of the sine-wave group G[3] is equivalent to three times T1. An ending time point T(K−1) of the sine-wave group G[K−1] is equivalent to (K−1) times T1. An ending time point TK of the sine-wave group G[K] is equivalent to K times T1.

Regarding transceiver devices in some prior arts, baseband signals outputted by their internal pre-distortion circuits in the pre-distortion mode are continuous signals. The continuous signals make the peak currents larger. The larger peak currents introduce additional power supply burden of the systems and increase cost of the systems.

Compared to the prior arts, in the present disclosure, the baseband signal S1 outputted by the pre-distortion circuit 110 in the pre-distortion mode is a discontinuous signal. A capacitor in the transmitter circuit 131 can be discharged during the idle time interval D2 in the discontinuous signal to reduce the peak current, thereby reducing the power supply burden of the system and the cost of the system.

Reference is made to FIG. 4 again. In some embodiments, the time length m of the signal time interval D1 and the time length n of the idle time interval D2 can be adjusted according to actual requirements to reduce the peak current more effectively. For example, when the time length m of the signal time interval D1 is fixed and the time length n of the idle time interval D2 is longer, reduction of the peak current is greater.

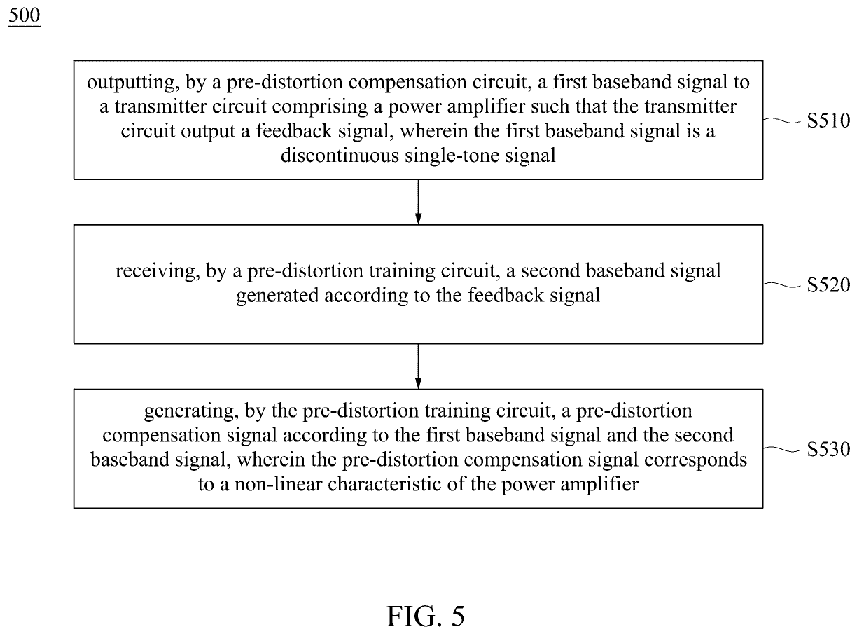

Reference is made to FIG. 5. FIG. 5 is a flow diagram of a pre-distortion compensation signal generation method 500 according to some embodiments of the present disclosure.

As illustrated in FIG. 5, the pre-distortion compensation signal generation method 500 includes operation S510, operation S520, and operation S530. In some embodiments, the pre-distortion compensation signal generation method 500 is applied to the transceiver device 100 in FIG. 1, but the present disclosure is not limited thereto. For better understanding, the pre-distortion compensation signal generation method 500 is described in following paragraphs with reference to FIG. 1.

In operation S510, the pre-distortion compensation circuit 111 outputs the baseband signal S1 to the transmitter circuit 131 including the power amplifier 1313 such that the transmitter circuit 131 outputs the feedback signal S5. The baseband signal S1 is the discontinuous single-tone signal.

In operation S520, the pre-distortion training circuit 112 receives the baseband signal S8 generated according to the feedback signal S5.

In operation S530, the pre-distortion training circuit 112 generates the pre-distortion compensation signal S9 according to the baseband signal S1 and the baseband signal S8. The pre-distortion compensation signal S9 corresponds to the non-linear characteristic of the power amplifier 1313.

Details about these operations are described in aforementioned embodiments, so they are not described herein again.

As described above, in the present disclosure, the capacitor in the transmitter circuit can be discharged during the idle time interval in the discontinuous single-tone signal to reduce the peak current, thereby reducing the power supply burden of the system and the cost of the system.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A transceiver device, comprising:
a pre-distortion circuit configured to output a first baseband signal, wherein the first baseband signal is a discontinuous single-tone signal; and
a radio frequency end circuit coupled to the pre-distortion circuit and comprising:
a transmitter circuit comprising a power amplifier and configured to output a loop-back signal according to the first baseband signal; and
a receiver circuit configured to receive the loop-back signal,
wherein the pre-distortion circuit is further configured to receive a second baseband signal generated according to the loop-back signal, and generate a pre-distortion compensation signal according to the first baseband signal and the second baseband signal, wherein the pre-distortion compensation signal corresponds to a non-linear characteristic of the power amplifier.

2. The transceiver device of claim 1, wherein the discontinuous single-tone signal comprises K sine-wave groups, and each of the K sine-wave groups comprises N discontinuous sine waves,
wherein K is a positive integer number greater than 1, and N is a positive integer number greater than 1.

3. The transceiver device of claim 2, wherein there is an idle time interval between any two adjacent sine waves of the N discontinuous sine waves.

4. The transceiver device of claim 2, wherein the K sine-wave groups are with a plurality of different amplitudes.

5. The transceiver device of claim 4, wherein a former one of the K sine-wave groups in a time sequence is with a first amplitude, and a latter one of the K sine-wave groups in the time sequence is with a second amplitude,
wherein the second amplitude is greater than the first amplitude.

6. The transceiver device of claim 2, wherein the N discontinuous sine waves are with a same amplitude.

7. The transceiver device of claim 1, wherein the pre-distortion circuit comprises:
a pre-distortion compensation circuit configured to output the first baseband signal; and
a pre-distortion training circuit configured to receive the second baseband signal, generate the pre-distortion compensation signal according to the first baseband signal and the second baseband signal, and output the pre-distortion compensation signal to the pre-distortion compensation circuit.

8. The transceiver device of claim 7, wherein the pre-distortion compensation circuit is further configured to output a combination signal of an original transmission signal and the pre-distortion compensation signal.

9. A pre-distortion circuit, comprising:
a pre-distortion compensation circuit configured to output a first baseband signal to a transmitter circuit comprising a power amplifier such that the transmitter circuit outputs a feedback signal, wherein the first baseband signal is a discontinuous single-tone signal; and
a pre-distortion training circuit configured to receive a second baseband signal generated according to the feedback signal, and generate a pre-distortion compensation signal according to the first baseband signal and the second baseband signal, wherein the pre-distortion compensation signal corresponds to a non-linear characteristic of the power amplifier.

10. The pre-distortion circuit of claim 9, wherein the discontinuous single-tone signal comprises K sine-wave groups, and each of the K sine-wave groups comprises N discontinuous sine waves,
wherein K is a positive integer number greater than 1, and N is a positive integer number greater than 1.

11. The pre-distortion circuit of claim 10, wherein there is an idle time interval between any two adjacent sine waves of the N discontinuous sine waves.

12. The pre-distortion circuit of claim 10, wherein the K sine-wave groups are with a plurality of different amplitudes.

13. The pre-distortion circuit of claim 12, wherein a former one of the K sine-wave groups in a time sequence is with a first amplitude, and a latter one of the K sine-wave groups in the time sequence is with a second amplitude,
wherein the second amplitude is greater than the first amplitude.

14. The pre-distortion circuit of claim 10, wherein the N discontinuous sine waves are with a same amplitude.

15. A pre-distortion compensation signal generation method, comprising:
outputting, by a pre-distortion compensation circuit, a first baseband signal to a transmitter circuit comprising a power amplifier such that the transmitter circuit outputs a feedback signal, wherein the first baseband signal is a discontinuous single-tone signal;
receiving, by a pre-distortion training circuit, a second baseband signal generated according to the feedback signal; and
generating, by the pre-distortion training circuit, a pre-distortion compensation signal according to the first baseband signal and the second baseband signal, wherein the pre-distortion compensation signal corresponds to a non-linear characteristic of the power amplifier.

16. The pre-distortion compensation signal generation method of claim 15, wherein the discontinuous single-tone signal comprises K sine-wave groups, and each of the K sine-wave groups comprises N discontinuous sine waves,
wherein K is a positive integer number greater than 1, and N is a positive integer number greater than 1.

17. The pre-distortion compensation signal generation method of claim 16, wherein there is an idle time interval between any two adjacent sine waves of the N discontinuous sine waves.

18. The pre-distortion compensation signal generation method of claim 16, wherein the K sine-wave groups are with a plurality of different amplitudes.

19. The pre-distortion compensation signal generation method of claim 18, wherein a former one of the K sine-wave groups in a time sequence is with a first amplitude, and a latter one of the K sine-wave groups in the time sequence is with a second amplitude,
wherein the second amplitude is greater than the first amplitude.

20. The pre-distortion compensation signal generation method of claim 16, wherein the N discontinuous sine waves are with a same amplitude.
